(19) United States
(12) Patent Application Publication
(10) Pub. No.: US 2023/0415358 A1
(43) Pub. Date: Dec. 28, 2023

(54) GRIPPER ARRANGEMENT AND MANIPULATOR HAVING A GRIPPER ARRANGEMENT

(71) Applicant: TRUMPF Maschinen Austria GmbH & Co. KG., Pasching (AT)

(72) Inventors: Roberto VERONESE, Chieri (IT); Giovanni VIDOTTO, Chieri (IT)

(73) Assignee: TRUMPF Maschinen Austria GmbH & Co. KG., Pasching (AT)

(21) Appl. No.: 18/035,560

(22) PCT Filed: Nov. 17, 2021
(86) PCT No.: PCT/AT2021/060435

§ 371 Date: May 5, 2023

(30) Foreign Application Priority Data
Nov. 18, 2020 (AT) A51006/2020

(51) Int. Cl. B25J 15/06

(52) U.S. Cl. CPC B25J 15/06

(57) ABSTRACT

A gripping arrangement for gripping, holding and placing down workpieces, and a manipulator having a gripping arrangement, includes a connection interface for attachment to a manipulator and a pincer gripper with two pincer arms movable relative to one another by a pincer drive. In their closed position, the arms define a clamping plane extending therebetween and a longitudinal pincer axis extending parallel to the arms and in the clamping plane. An adhesion gripper having at least one vacuum or magnetic gripping element includes a plane of adhesive action for holding a workpiece, and is displaceable along an adjustment axis toward the longitudinal pincer axis relative to the pincer gripper between working and stand-by zones by an adjustment drive. The clamping plane and the plane of adhesive action are orthogonal to one another and the plane of adhesive action extends orthogonally to the longitudinal pincer axis.

The invention relates to a gripping arrangement for gripping, holding and placing down workpieces, in particular sheet metal workpieces, and a manipulator having a gripping arrangement.

Usually, according to the prior art, manipulators having vacuum gripping devices, i.e. having suction grippers, are used to grip workpieces such as sheet metal workpieces from a workpiece stack. However, since vacuum gripping device are often not very advantageous or even unsuitable to carry out processing steps on a bending machine or the like after gripping and/lifting, the workpieces to be manipulated are often passed on to a second manipulator, which is designed having a pincer gripper. Such an approach can be useful in particular for smaller or already bent workpieces. However, two manipulators are expensive and require a lot of space. Moreover, there is a risk of collisions and the freedom of movement of the manipulators can be limited.

To overcome these disadvantages, experts know combined manipulator arrangements, in which an individual manipulator is formed both for gripping by means of suction grippers and for gripping by means of a pincer gripper. However, the known formations are limited in their gripping and suction functionality and thus do not represent adequate and satisfying solutions.

For example, JP2019014027 A presents a bending robot having a combined pincer and suction gripper head. A suction gripper is arranged on a displaceable frame, wherein a plane of adhesive action of the suction gripper is aligned parallel to a clamping plane of the pincer gripper.

CN108927822 A also discloses a combined gripping device, wherein a pincer gripper is designed with suction pads at its front end. By moving the pincer arms, the suction grippers, which are rigidly mounted on the front ends of the pincer arms of the pincer gripper, are moved in a positively coupled manner. In this regard, a plane of adhesive action of the suction gripper is aligned orthogonal to the clamping plane of the pincer gripper.

It was the object of the present invention to overcome the shortcomings of the prior art and to provide means by means of which workpieces for a processing machine, in particular for a bending machine, can be manipulated in a quick and efficient manner.

This object is achieved by means of a gripping arrangement and a manipulator according to the claims.

The invention relates to a gripping arrangement for gripping, holding and placing down workpieces, in particular sheet metal workpieces, comprising a connection interface for attachment to a manipulator and a pincer gripper having a first pincer arm and a second pincer arm. The pincer arms are movable relative to one another by means of a pincer drive and in their closed position define a clamping plane extending between the pincer arms. The pincer arms in their closed position define a longitudinal pincer axis extending parallel to the pincer arms and in the clamping plane. The gripping arrangement further comprises an adhesion gripper having at least one vacuum gripping element or having at least one magnetic gripper element. The adhesion gripper has a plane of adhesive action for holding a workpiece and is displaceable along an adjustment axis in the direction of the longitudinal pincer axis relative to the pincer gripper between a working zone and a stand-by zone by means of an adjustment drive. In this regard, it is provided that the clamping plane and the plane of adhesive action are aligned at a right angle to one another and that the plane of adhesive action extends at a right angle to the longitudinal pincer axis.

By the formation of a gripping arrangement according to the invention, two full grippers, i.e. two grippers each fully functional on their own, are realized in one single, structurally integrated and/or combined gripping arrangement. In this context, the term “full grippers” is understood as a pincer or adhesion gripper arrangement, the functionality, stability and freedom of movement of which is at least largely equivalent to a single, structurally individual pincer or adhesion gripper arrangement. Thus, the functional range of the pincer gripper of the gripping arrangement according to the invention is not or just to a slight extent affected by the joint formation with the adhesion gripper. The same applies to the adhesion gripper.

Neither the pincer gripper nor the adhesion gripper—as compared to two separate and/or independently formed gripping arrangements, which are each attached to a separate manipulator—are limited in their functionality. Hence, mutual blocking of the grippers is largely avoided.

By the arrangement of the two grippers according to the invention, a risk of mutual obstructions or even collisions is at least largely avoided or even completely reduced. The formation according to the invention impresses with a high degree of freedom of movement of both grippers.

In particular when the adhesion gripper is displaced into its stand-by zone, the pincer gripper can work without any limitations of movement. In this regard, the pincer grippers are impeded neither by the vacuum gripping elements nor by the magnetic gripper element itself, nor by potential pneumatic lines. Moreover, re-gripping, i.e. a direct workpiece transfer from the adhesion gripper to the pincer gripper and vice versa, is possible because the adhesion gripper can be displaced along its adjustment axis in the direction of the longitudinal pincer axis and because the clamping plane and the plane of adhesive action are aligned at a right angle to each other. Thus, the grippers can also be used simultaneously where required. Loss of time due to an intermediate work step, such as placing down the workpiece, is thus reduced.

Due to the possibility for both grippers to be used as full grippers, the number of required re-gripping or re-positioning operations is reduced and thus the entire manipulation and processing operation becomes more efficient. By the clamping plane and the plane of adhesive action being arranged at a right angle to one another and the plane of adhesive action extending at a right angle to the longitudinal pincer axis, less manipulator movements are required, meaning that less re-positioning of the manipulator is required to carry out the necessary working steps. Moreover, the adjustment paths to be carried out by a manipulator for the entire gripping arrangement can also be kept as short as possible. This particularly applies after a carried-out processing and/or bending step, after which the workpiece and/or the sheet metal bending part has limbs that are angled towards each other. This reduces the cycle times of the workpiece processing and thus increases the efficiency of the process.

Moreover, the two grippers are loadable to at least approximately the same extent and can thus manipulate the same workpiece weights. Hence, damage to the manipulator as a result of overloading and also accidents and hazards for an operator can at least largely be prevented.

In this regard, a displacement of the adhesion gripper along the adjustment axis can be carried out in a stepless manner and thus an optimal and/or desired position can be set. In this regard, the stand-by zone and/or the working zone can preferably be regions along the adjustment axis. Preferably, the adhesion gripper cannot be actuated while a position in the stand-by zone is being taken. Preferably, the adhesion gripper can take a plurality of advantageous positions in the working zone and can be displaced between an axially outermost and an axially innermost working zone.

Experts know a plurality of formations of adhesion grippers and pincer grippers, which are not elucidated in detail in this document. In this regard, it can be possible for both a vacuum gripping element as well as a magnetic gripper element to be activated pneumatically. While vacuum gripping elements can be formed as suction grippers having a usually cup-shaped suction element, magnetic gripper elements can comprise a permanent magnet, wherein said permanent magnet can be displaceable by means of a pressure-activated piston or cylinder.

Moreover, it can be useful if the longitudinal pincer axis and the adjustment axis are positioned coaxially. Hence, a load capacity of the gripping arrangement or the manipulator can be increased and optionally heavy or large workpieces can also be manipulated. Moreover, the gripping arrangement can be designed more compact when the axes are arranged coaxially, which can further reduce the risk of collisions or motion blockages. In particular, a coaxial arrangement can also allow for and/or facilitate a rotation of workpieces, whereby the application possibilities of the gripping arrangement can be additionally extended.

It can further be provided that the longitudinal pincer axis and the adjustment axis are positioned in different orientations. Such a further embodiment can be advantageous to extend the application possibilities of the pincer gripper. In this regard, for example, larger opening widths of the pincer arm can be realized.

Moreover, it can be provided that at least three vacuum gripping elements or at least three magnetic gripper elements are formed, which are arranged annularly around the pincer gripper axis. In this context, it can also be advantageous if the vacuum gripping element or the magnetic gripper element are arranged around the pincer gripper when the adhesion gripper is in the working zone. Such a further embodiment can represent a very loadable arrangement. By multiple gripper elements being positioned annularly and centered around the pincer gripper, a high number of gripping elements can be realized. Hence, a full adhesion gripper can be realized which is also suitable for manipulating large, flat or bulky workpieces. Moreover, by means of this further embodiment, re-gripping from the pincer gripper to the adhesion gripper and vice versa can be facilitated. Advantageously, the vacuum gripping element and/or the magnetic gripper elements can be arranged at an equal distance to the adjustment axis. This can especially be the case where the longitudinal pincer axis and the adjustment axis are positioned coaxially.

A design, according to which it can be provided that the second pincer arm is arranged rigidly in relation to the pincer drive and that the first pincer arm is mounted so as to be movable relative to the second pincer arm, is also advantageous.

By means of thus formed pincer arms, a risk of collisions between the pincer gripper and the adhesion gripper can be reduced or even prevented. This is mainly due to the fact that such an arrangement can be easily controlled mechanically if the adhesive gripper is located directly below and/or in the vicinity of the rigid, i.e. non-movable, pincer arm. In this regard, the pincer gripper and the adhesion gripper can optionally also be positioned very close and/or narrow to one another. Thus, a compact construction of the gripping arrangement can be realized.

According to a further embodiment, it is possible that the longitudinal pincer axis and a central axis of the connection interface are positioned coaxially to a manipulator. Hence, a highly loadable position for the gripping arrangement can be realized by it being formed centrally on the outermost manipulator arm.

It can further be useful if a pivot axis of the first pincer arm is formed at a right angle to the longitudinal pincer axis and parallel to the clamping plane or in the clamping plane, wherein the first pincer arm is formed so as to be pivotable about the pivot axis. This can in particular be useful where one of the pincer arms is formed to be rigid and the other one is formed to be movable.

Moreover, it can be provided that the first pincer arm and the second pincer arm are linearly movable with respect to one another. Hence, workpieces having different workpiece thicknesses and/or sheet thicknesses can be gripped reliably and, in this regard, a constant contact pressure can be ensured.

Moreover, it can be provided that the plane of adhesive action, when the axially outermost working zone of the adhesion gripper is taken, projects beyond an end face of the pincer gripper in the axial direction of the adjustment axis. By the possibility of the adhesion gripper being moved out so far and thus projecting beyond a tip of the pincer gripper and/or its end face, a workpiece can possible be gripped more easily. Possible obstructions and/or limitations of movement can thus be prevented by the pincer gripper.

According to a particular embodiment, it is possible that the pincer arms, by means of at least one stop or locking element or controlled by a controller, cannot be transferred to a partially or fully open position when the adhesion gripper is moved into the working zone. Hence, an efficient safety feature for the prevention or avoidance of collisions can be realized.

According to an advantageous embodiment, it can be provided that the pincer drive and the adjustment drive can be activated independently of one another and simultaneously. Hence, re-gripping and/or passing on of a workpiece from the pincer gripper to the adhesion gripper and vice versa can be facilitated. Hence, by means of this further embodiment, an additional flexibilization of the application possibilities of the gripping arrangement can be achieved.

It can in particular be advantageous if the pincer drive and/or the adjustment drive comprises a pressure-driven cylinder, preferably a pneumatic cylinder.

It can further be provided that the pressure-driven cylinders can be acted upon by pressure by means of a joint pressure line, wherein at least one valve is formed in the pressure line, said valve being controllable by means of the controller. In particular, by the formation of joint pressure lines and the pressure supply, a structurally simple setup and thus compact design can be realized. This can further have a positive effect on the freedom of movement of the adhesion gripper and the pincer gripper. Preferably, the valve is formed as a switching valve, which can enable selective pressurization of the adjustment drive and the pincer drive. It might also be of advantage if the gripper elements can also be supplied and/or acted upon with pressure by the valve or switching valve.

Moreover, it can be provided that the valve is configured for simultaneously supplying the pressure-driven cylinders and the at least one vacuum gripping element or the at least one magnetic gripper element.

An embodiment, according to which it can be provided that the pressure-driven cylinder of the adjustment drive comprises an annular cylinder space, said annular cylinder space being arranged around the pressure-driven cylinder of the pincer drive, wherein a cylinder axis of the pressure-driven cylinder is positioned coaxially to the adjustment axis, is also advantageous. Hence, the construction can be even more compact and the risk of collisions or limitations of movement can be reduced.

The invention also relates to a manipulator having a gripping arrangement for gripping, holding and placing down workpieces, in particular sheet metal workpieces, wherein the gripping arrangement is designed according to one of claims. The advantages offered thereby can be gathered from the description above.

For the purpose of better understanding of the invention, it will be elucidated in more detail by means of the figures below.

These show in a respectively very simplified schematic representation:

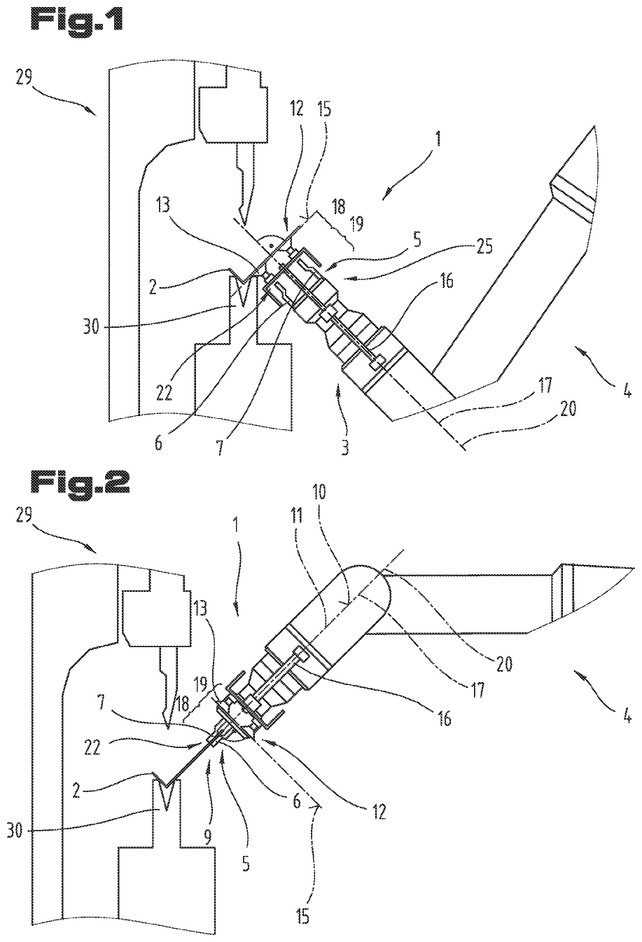

FIG. 1 a lateral view of a bending machine and a manipulator having a gripping arrangement with adhesion gripper in a working zone;

FIG. 2 a further lateral view of the bending machine and the manipulator of FIG. 1 with the adhesion gripper in its stand; by zone;

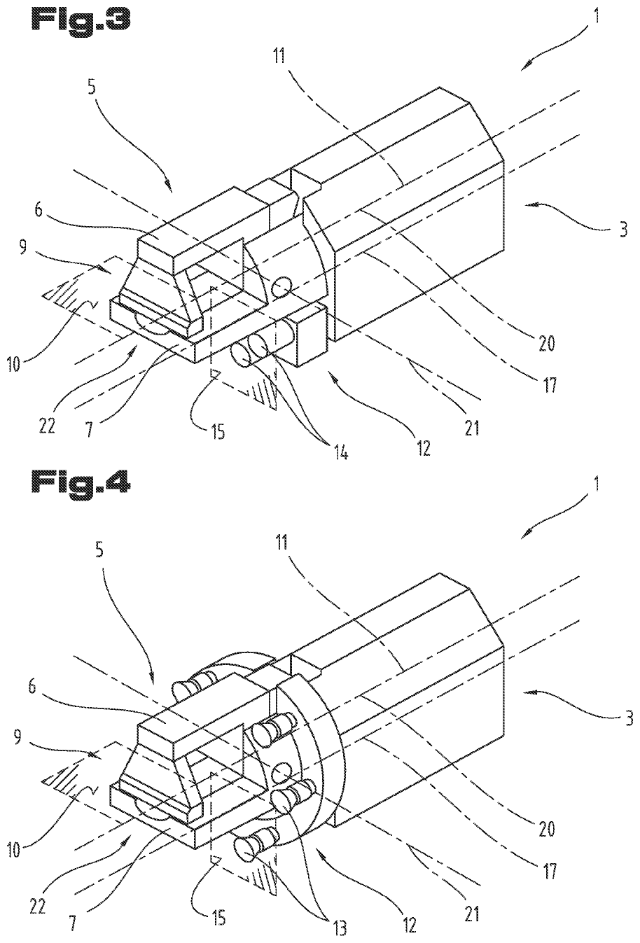

FIG. 3 a gripping arrangement having magnetic gripper elements in a three-dimensional view;

FIG. 4 a further gripping arrangement having vacuum gripping elements in a three-dimensional view;

FIG. 5 a sectional view of a further gripping arrangement in a first position;

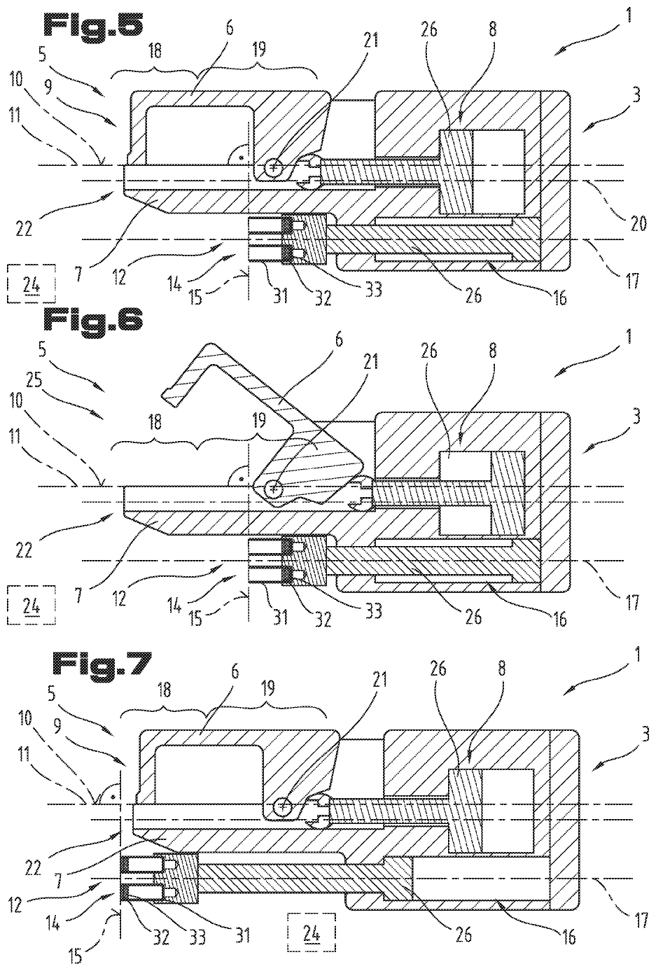

FIG. 6 a sectional view of the gripping arrangement of FIG. 5 in a second position;

FIG. 7 a sectional view of the gripping arrangement of FIG. 5 in a third position;

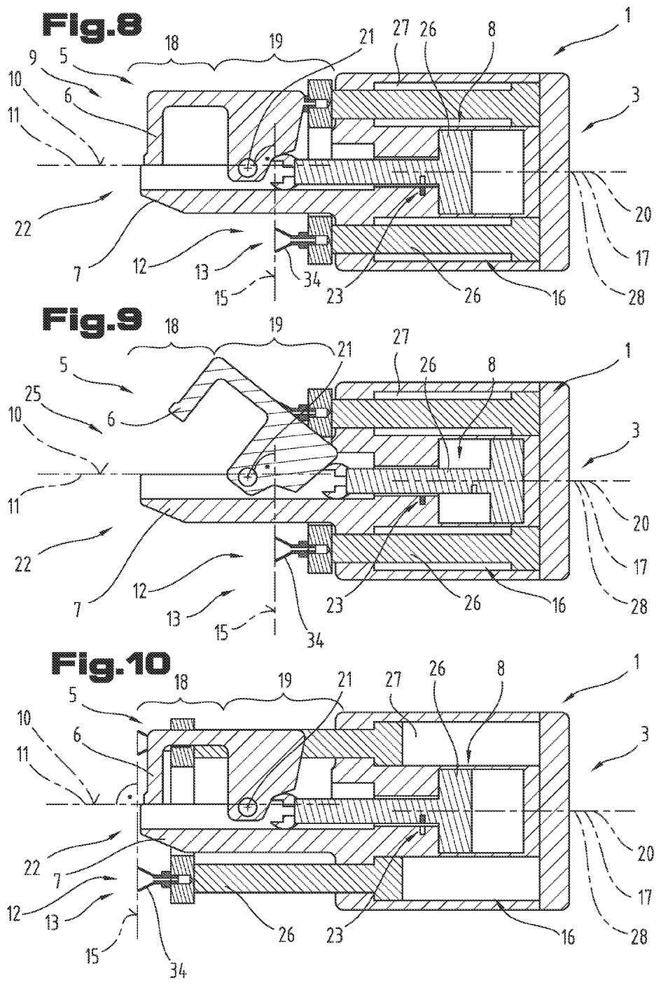

FIG. 8 a sectional view of a further gripping arrangement in a first position;

FIG. 9 a sectional view of the gripping arrangement of FIG. 8 in a second position;

FIG. 10 a sectional view of the gripping arrangement of FIG. 8 in a third position.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIGS. 1 and 2 show gripping positions and/or working positions of a manipulator 4 having a gripping arrangement 1 by way of example. The manipulator 4 carries out working movements and/or manipulations on a workpiece 2, wherein the workpiece 2 is provided in a bending machine 29 shown by way of example. Of course, any other processing machine can be provided in place of the bending machine 29. In the shown example, the workpiece 2 is a sheet metal workpiece folded in an L-shape.

The gripping arrangement 1 comprises a connection interface 3 for attachment to the shown manipulator 4. Moreover, the gripping arrangement 1 is formed having a pincer gripper 5, which comprises a first pincer arm 6 and a second pincer arm 7. The pincer arms 6,7 are movable relative to one another by means of a pincer drive 8 and in their closed position 9 define a clamping plane 10 extending between the pincer arms 6, 7. The closed position 9 of the pincer arms 6, 7 is illustrated in FIG. 2. Moreover, the pincer arms 6, 7 in their closed position 9 define a longitudinal pincer axis 11 extending parallel to the pincer arms 6, 7 and in the clamping plane 10.

The gripping arrangement 1 further comprises an adhesion gripper 12 having at least one vacuum gripping element 13 or having at least one magnetic gripper element 14, wherein the adhesion gripper 12 is formed having a vacuum gripping element 13 in FIGS. 1 and 2. The adhesion gripper 12 has a plane of adhesive action 15 for holding workpieces 2 and is displaceable along an adjustment axis 17 in the direction of the longitudinal pincer axis 11 relative to the pincer gripper 5 between a working zone 18 and a stand-by zone 19 by means of an adjustment drive 16. In FIG. 1, the adhesion gripper 12 is displaced into a position in the working zone 18 and holds and/or positions the workpiece 2 in the bending machine 29 shown by way of example, i.e. on a lower tool 30 of the bending machine 29. In this context, holding can be performed by supplying the vacuum gripping element 13 with vacuum. FIG. 2 shows the adhesion gripper 12 in a position in the stand-by zone 19. Here, the workpiece 2 is held in the bending machine 29 by means of the pincer gripper 5. FIGS. 1 and 2 show that the clamping plane 10 and the plane of adhesive action 15 are aligned at a right angle to one another and that the plane of adhesive action 15 extends at a right angle to the longitudinal pincer axis 11.

The longitudinal pincer axis 11 and the adjustment axis 17 can be positioned in different orientations. However, alternatively, it is also conceivable that the longitudinal pincer axis 11 and the adjustment axis 17 are positioned coaxially. The longitudinal pincer axis 11 and a central axis 20 of the connection interface 3 to the manipulator 4 can be positioned coaxially.

The first pincer arm 6 and the second pincer arm 7 can be formed to be linearly movable with respect to one another. In this regard, the pincer arms can be movable synchronously, but also independently of each other or individually. It can be useful if the plane of adhesive action 15, when the axially outermost working zone 18 of the adhesion gripper 12 is taken, projects beyond an end face 22 of the pincer gripper 5 in the axial direction of the adjustment axis 17, as is illustrated in FIG. 1. The pincer drive 8 and the adjustment drive 16 can be activated independently of one another and simultaneously.

FIGS. 3 and 4 show two conceivable embodiments of gripping arrangements 1 in a three-dimensional view. In this regard, the gripping arrangement 1 in FIG. 3 is formed having an adhesion gripper 12 with magnetic gripper elements 14, while the gripping arrangement 1 in FIG. 4 comprises an adhesion gripper 12 with vacuum gripping elements 13. To avoid unnecessary repetitions, the detailed description to FIGS. 1 and 2 above is pointed to and made reference to, wherein again, equal reference numbers and/or component designations are used for equal parts as before in FIGS. 1 and 2.

In this regard, the gripping arrangements 1 in FIGS. 3 and 4 comprise a connection interface 3 for attachment to a manipulator 4, a pincer gripper 5 and an adhesion gripper 12. The pincer gripper 5 is formed having a first pincer arm 6 and a second pincer arm 7, which are movable relative to one another by means of a pincer drive 8 and which, in their closed position 9, define a clamping plane 10 extending between the pincer arms 6, 7. The pincer arms 6, 7, in their closed position 9, further define a longitudinal pincer axis 11 extending parallel to the pincer arms 6, 7 and in the clamping plane 10. The adhesion gripper 12 is formed either according to the example in FIG. 4 having at least one vacuum gripping element 13 or according to the example in FIG. 3 having at least one magnetic gripper element 14. In this regard, the adhesion gripper 12 comprises a plane of adhesive action 15 for holding workpieces 2, wherein the adhesion gripper 12 is displaceable along an adjustment axis 17 in the direction of the longitudinal pincer axis 11 relative to the pincer gripper 5 between a working zone 18 and a stand-by zone 19 by means of an adjustment drive 16. As in FIGS. 1 and 2, the clamping plane 10 and the plane of adhesive action 15 are aligned at a right angle with respect to one another, and the plane of adhesive action 15 extends at a right angle to the longitudinal pincer axis 11.

It is shown in both gripping arrangements 1 in FIGS. 3 and 4 that the second pincer arm 7 can be arranged rigidly in relation to the pincer drive 8 and that the first pincer arm 6 is mounted so as to be movable relative to the second pincer arm 7. In this regard, to prevent collisions and to increase the freedom of movement, the adhesion gripper 12 can be arranged below the rigid, second pincer arm 7, as is shown in FIG. 3. The two FIGS. 3 and 4 also show that a pivot axis 21 of the first pincer arm 6 can be formed at a right angle to the longitudinal pincer axis 11 and parallel to the clamping plane 10 or in the clamping plane 10, wherein the first pincer arm 6 can be formed to be pivotable about the pivot axis 21.

While in the gripping arrangement 1 in FIG. 3 the longitudinal pincer axis 11 and the adjustment axis 17 are positioned in different orientations, the longitudinal pincer axis 11 and the adjustment axis 17 are shown being positioned coaxially in FIG. 4. According to the exemplary embodiment in FIG. 4, at least three—or, according to the example, also six—vacuum gripping elements 13 can be formed, which can be arranged annularly around the longitudinal pincer axis 11. In this regard, the vacuum gripping elements 13 can be spaced apart from the adjustment axis 17 and/or the central axis of the annular adhesion gripper 12 at a constant distance.

FIGS. 5, 6 and 7 show sectional views of a further gripping arrangement 1, wherein the gripping arrangement 1 is designed similarly to the embodiment shown in FIG. 3. In this regard, three conceivable positions and/or working positions of the gripping arrangement 1 are shown by way of example. FIGS. 8, 9 and 10 also show sectional views of a further gripping arrangement 1, wherein this gripping arrangement 1 is comparable to the one shown in FIG. 4. Here, the same working positions as in FIGS. 5, 6 and 7 are shown. However, here again, reference is made to the above descriptions to avoid unnecessary repetitions. In the exemplary embodiments according to FIGS. 5 to 10, it is provided that the clamping plane 10 and the plane of adhesive action 15 are aligned at a right angle to one another and that the plane of adhesive action 15 extends at a right angle to the longitudinal pincer axis 11. At this point, it should in particular be noted that the functional description below of the gripping arrangement 1, as well as its drives and its gripper elements is to be understood in an exemplary manner and, of course, any conceivable formation is possible. Thus, for example, a plurality of advantageous designs is possible for controlling the drives and for activating the gripper elements.

It is shown in particular in FIGS. 5, 6 and 7 that when the adhesion gripper 12 is displaced into the working zone 18, the pincer arms 6, 7, controlled by a controller 24, cannot be moved into a partially or maximally open position 25. Alternatively to this, it is shown in FIGS. 8 and 9 and in particular in FIG. 10 that when the adhesion gripper 12 is displaced into the working zone 18, the pincer arms 6, 7, by means of at least one stop or locking element 23, cannot be moved into a partially or maximally open position 25. In FIGS. 8, 9 and 10, the stop or locking element 23 is only roughly sketched. Hence, the stop or locking element 23 can lock and/or block a movement of the pincer drive 8 and/or the pressure-driven cylinder 26 of the pincer drive 8 when the adhesion gripper 12 is fully extracted. Alternatively and as is not shown in the figures, the stop or locking element 23 can also be the adhesion gripper 12 itself or be a workpiece formed with the adhesion gripper 12. Thus, for example, in the case of an annular design, it can prevent an undesired opening of the pincer arms 6, 7.

Advantageously, the pincer drive 8 and the adjustment drive 16 can each comprise a pressure-driven cylinder 26, wherein the pressure-driven cylinder 26 preferably is a pneumatic cylinder. It is useful if the pressure-driven cylinders 26 can be acted upon by pressure by means of a joint pressure line. In this regard, at least one valve can be formed in the pressure line, said valve being controllable by means of a controller 24. Optionally, it is also possible that the valve is designed for simultaneous supply of the pressure-driven cylinders 26 and the at least one vacuum gripping element 13, and/or the at least one magnetic gripper element 14. However, it can also be useful if the at least one vacuum gripping element 13 and/or the at least one magnetic gripper element 14 are operated with a vacuum. For reasons of clarity, FIGS. 5 to 10 are rough, schematic representations and/or sectional views. For this reason, neither control lines, nor pressure lines or valves are shown in the Figures.

FIGS. 8, 9 and 10 show that the pressure-driven cylinder 26 of the adjustment drive 16 can comprise an annular cylinder space 27, which annular cylinder space 27 can be arranged around the pressure-driven cylinder 26 of the pincer drive 8, wherein a cylinder axis 28 of the pressure-driven cylinder 26 can be positioned coaxially to the adjustment axis 17.

The magnetic gripper elements 14—that are shown highly schematic and merely as an exemplary sketch—are formed having a hollow-cylindrical body 31 in FIGS. 5, 6 and 7 and comprise a cylindrical permanent magnet 32, which is accommodated in the hollow-cylindrical body 31 along with an element 33 acted upon by pressure. When the element 33 is acted upon by pressure, it is displaced to the or at least into the vicinity of the plane of adhesive action 15 along with the permanent magnet 32. Thereby, workpieces 2 can be magnetically held on the plane of adhesive action 15. Alternatively to this, the vacuum gripping elements 13, which are also shown in a highly schematic manner in FIGS. 8, 9 and 10, are formed having suction cups 34.

FIGS. 5 and 8 each show the same working position, in which the adhesion gripper 12 is displaced into its stand-by zone 19. In this regard, the pressure-driven cylinder 26 of the adjustment drive 16 is not acted upon by pressure. In this working position, the pressure-driven cylinder 26 of the pincer drive 8 is acted upon by pressure and effects closing of the pincer arms 6, 7. Thus, the pincer gripper 5 is in its closed position 9. For example, the pressure-driven cylinders 26 can be of single-acting design and held in this position by means of return spring mechanisms—which are not shown. However, of course, it would also be conceivable and optionally useful for the pressure-driven cylinders 26 to be of double-acting design.

In FIGS. 6 and 9 the adhesion gripper 12 is shown in the same position as in FIGS. 5 and 8. However, in this context, the pressure-driven cylinder 26 of the pincer drive 8 is not acted upon by pressure anymore and is thus shown in its rest position. By the pressure-driven cylinder 26 of the pincer drive 8 taking its rest position, the first pincer arm 6 opens up while being pivoted along its pivot axis 21. Thus, the pincer gripper 5 is in its open position 25.

In FIGS. 7 and 10, the pressure-driven cylinder 26 of the pincer gripper 5 is acted upon by pressure analogously to FIGS. 5 and/or 8 and the first pincer arm 6 is thus closed, i.e. the pincer gripper 5 is in its closed position 9. The pressure-driven cylinder 26 of the adhesion gripper 12 is in its outermost position and thus the adhesion gripper 12 is displaced into the working zone 18. Here, the adhesion gripper 12 projects beyond the end face 22 of the pincer gripper 5 in the axial direction of the adjustment axis 17.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

### LIST OF REFERENCE NUMBERS

1 Gripping arrangement
2 Workpiece
3 Connection interface
4 Manipulator
5 Pincer gripper
6 First pincer arm
7 Second pincer arm
8 Pincer drive
9 Closed position
10 Clamping plane
11 Longitudinal pincer axis
12 Adhesion gripper
13 Vacuum gripping element
14 Magnetic gripper element
15 Plane of adhesive action
16 Adjustment drive
17 Adjustment axis
18 Working zone
19 Stand-by zone
20 Central axis
21 Pivot axis
22 End face
23 Stop or locking element
24 Controller
25 Open position
26 Pressure-driven cylinder
27 Annular cylinder space
28 Cylinder axis
29 Bending machine
30 Lower tool
31 Hollow-cylindrical body
32 Permanent magnet
33 Element acted upon by pressure
34 suction cup

1. A gripping arrangement (1) for gripping, holding and placing down workpieces (2), in particular sheet metal workpieces, comprising
a connection interface (3) for attachment to a manipulator (4),
a pincer gripper (5) having a first pincer arm (6) and a second pincer arm (7),
wherein the pincer arms (6, 7) are movable relative to one another by means of a pincer drive (8) and, in their closed position (9), define a clamping plane (10) extending between the pincer arms (6, 7), and
wherein the pincer arms (6, 7) in their closed position (9) define a longitudinal pincer axis (11) extending parallel to the pincer arms (6, 7) and in the clamping plane (10),
an adhesion gripper (12) having at least one vacuum gripping element (13) or having at least one magnetic gripper element (14),
wherein the adhesion gripper (12) comprises a plane of adhesive action (15) for holding a workpiece (2),
wherein the adhesion gripper (12) is displaceable along an adjustment axis (17) in the direction of the longitudinal pincer axis (11) relative to the pincer gripper (5) between a working zone (18) and a stand-by zone (19) by means of an adjustment drive (16),
wherein
the clamping plane (10) and the plane of adhesive action (15) are aligned at a right angle to one another, and
wherein the plane of adhesive action (15) extends at a right angle to the longitudinal pincer axis (11).

2. The gripping arrangement (1) according to claim 1, wherein the longitudinal pincer axis (11) and the adjustment axis (17) are positioned coaxially.

3. The gripping arrangement (1) according to claim 1, wherein the longitudinal pincer axis (11) and the adjustment axis (17) are positioned in different orientations.

4. The gripping arrangement (1) according to claim 1, wherein at least three vacuum gripping elements (13) or at least three magnetic gripper elements (14) are formed, which are arranged annularly around the longitudinal pincer axis (11).

5. The gripping arrangement (1) according to claim 1, wherein the second pincer arm (7) is arranged rigidly in relation to the pincer drive (8) and wherein the first pincer arm (6) is mounted so as to be movable relative to the second pincer arm (7).

6. The gripping arrangement (1) according to claim 1, wherein the longitudinal pincer axis (11) and a central axis (20) of the connection interface (3) are positioned coaxially to a manipulator (4).

7. The gripping arrangement (1) according to claim 1, wherein a pivot axis (21) of the first pincer arm (6) is formed at a right angle to the longitudinal pincer axis (11) and parallel to the clamping plane (10) or in the clamping plane (10), wherein the first pincer arm (6) is formed to be pivotable about the pivot axis (21).

8. The gripping arrangement (1) according to claim 1, wherein the first pincer arm (6) and the second pincer arm (7) are linearly movable with respect to one another.

9. The gripping arrangement (1) according to claim 1, wherein the plane of adhesive action (15), when the axially outermost working zone (18) of the adhesion gripper (12) is taken, projects beyond an end face (22) of the pincer gripper (5) in the axial direction of the adjustment axis (17).

10. The gripping arrangement (1) according to claim 1, wherein the pincer arms (6, 7), by means of at least one stop or locking element (23) or controlled by a controller (24), cannot be transferred to a partially or fully open position (25) when the adhesion gripper (12) is moved into the working zone (18).

11. The gripping arrangement (1) according to claim 1, wherein the pincer drive (8) and the adjustment drive (16) can be activated independently of one another and simultaneously.

12. The gripping arrangement (1) according to claim 1, wherein the pincer drive (8) and/or the adjustment drive (16) comprises a pressure-driven cylinder (26), preferably a pneumatic cylinder.

13. The gripping arrangement (1) according to claim 12, wherein the pressure-driven cylinders (26) can be acted upon by pressure by means of a joint pressure line, wherein at least one valve is formed in the pressure line, said valve being controllable by means of the controller (24).

14. The gripping arrangement (1) according to claim 13, wherein the valve is configured for simultaneously supplying the pressure-driven cylinders (26) and the at least one vacuum gripping element (13) or the at least one magnetic gripper element (14).

15. The gripping arrangement (1) according to claim 12, wherein the pressure-driven cylinder (26) of the adjustment drive (16) comprises an annular cylinder space (27), which annular cylinder space (27) is arranged around the pressure-driven cylinder (26) of the pincer drive (8), wherein a cylinder axis (28) of the pressure-driven cylinder (26) can be positioned coaxially to the adjustment axis (17).

16. A manipulator (4) having a gripping arrangement (1) for gripping, holding and placing down workpieces (2), in particular sheet metal workpieces, wherein the gripping arrangement (1) is designed according to claim 1.
